(19) United States
(12) Patent Application Publication
(10) Pub. No.: US 2010/0006405 A1
(43) Pub. Date: Jan. 14, 2010

(54) Circuit Breaker and Method for its Production

(75) Inventors: Jurgen Einschenk, Panketal (DE); Christian Heinrich, Falkensee (DE); Thomas Rädisch, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/523,242

(22) PCT Filed: Jan. 15, 2008
(86) PCT No.: PCT/EP2008/050404

§ 371 Date: Jul. 15, 2009

(30) Foreign Application Priority Data
Jan. 17, 2007 (DE) 10 2007 003 131.0

(51) Int. Cl. H01H 9/00; H01H 11/00

(52) U.S. Cl. 200/42.01; 29/622

(57) ABSTRACT

A circuit breaker has a housing and switching elements arranged within the housing for switching electrical power. Each switching element has a longitudinal direction which corresponds to the direction of a current flow with the switching element closed or which is parallel thereto. The circuit breaker is a three-phase breaker and has three switching elements the longitudinal directions of which are parallel, the three switching elements being arranged adjacent to each other in a cross-section plane perpendicular to the longitudinal directions and forming the vertices of a triangle.

The invention relates to a circuit breaker, in particular for medium-voltage technology, having the features as claimed in the precharacterizing clause of claim 1.

A circuit breaker such as this is known from European patent specification EP 1 317 787. This circuit breaker has a housing in which a switching element is arranged. The use of oil or SF₆ gas is recommended for insulation of the switching element. The switching element has a longitudinal direction, which corresponds to the current flow direction of a current which passes through the switching element when it is switched on.

Said European patent specification also discloses a circuit breaker of a different type, in which a switching element is arranged outside, to be precise on, a housing. A drive for switching the switching element, which is located outside the housing, is located within the housing.

Circuit breakers having switching elements of the latter type, that is to say those with a switching element outside the housing, are also described in U.S. Pat. Nos. 6,760,206 and 6,858,172. These circuit breakers are three-pole circuit breakers, in which three switching elements are arranged in a row, that is to say on an imaginary line, outside the housing.

The invention is based on the object of specifying a circuit breaker which is designed to allow it to have a physical shape which is as small as possible.

On the basis of a circuit breaker of the type mentioned initially, this object is achieved according to the invention in that the circuit breaker has three poles and has three switching elements, whose longitudinal directions are parallel, with the three switching elements being located alongside one another on a cross-sectional plane which is located at right angles to said longitudinal directions, and forming corner points of an imaginary or virtual triangle.

One major advantage of the circuit breaker according to the invention is that it can be designed to be very compact since the switching elements are not arranged in a row but spatially distributed over a cross-sectional area, thus saving installation volume.

A further major advantage of the circuit breaker according to the invention is that the total weight of the circuit breaker is considerably less than that of previous circuit breakers, because the reduced switch volume means that less housing is required, and therefore less housing material.

A third major advantage of the circuit breaker according to the invention is that the weight saving and the size reduction result in better installation capabilities on pylons and the like.

In order to achieve a particularly compact design and therefore particularly low weight, it is considered to be advantageous for the three switching elements to be arranged “symmetrically” and, for example, to form corner points of an imaginary or virtual equilateral triangle. The distance between the corner points is preferably selected such that the dielectrically required separation between the electrical phases or poles amongst themselves and the dielectrically required separation between the electrical phases or the poles and the housing for switch operation are complied with.

The housing preferably has a cover wall through which two upper bushing elements, which are connected to one of the three switching elements, are passed. The two upper bushing elements are preferably located one behind the other in the longitudinal direction of the associated switching element.

With regard to a compact housing design, it is considered to be advantageous for two side walls to be adjacent to the cover wall, which side walls are preferably each at an angle of between 115 degrees and 125 degrees, preferably of 120 degrees, to the cover wall.

By way of example, two side bushing elements can in each case be passed through each of the two side walls, each of which is electrically associated with one and the same switching element; the bushing elements are preferably located one behind the other on each side wall, seen in the longitudinal direction of the associated switching element.

The upper bushing elements and the side bushing elements each, for example, provide an external connection of the circuit breaker.

Furthermore, the housing preferably has a base wall which is suitable for placing the circuit breaker down, and, for example runs parallel to the cover wall. In order to achieve a particularly compact design, the housing may also have two connection walls, one of which connects the base wall to one of the two side walls, and the other of which connects the base wall to the other of the two side walls.

Preferably, at least one of the connection walls is at an angle of between 115 degrees and 125 degrees, preferably of 120 degrees, to the base wall and/or to the associated side wall.

The longitudinal directions of the switching elements are preferably aligned parallel to the longitudinal direction of the housing.

By way of example, the bushing elements may each have an outer bushing section, which is located outside the housing, and an inner bushing section, which is located within the housing, with the two bushing sections being composed of different materials or having different materials. A choice of different materials such as this allows specific cost optimization, for example, the material of the outer bushing section is suitable for outdoor use, and the material of the inner bushing section is not suitable for outdoor use.

The material of the outer bushing section is preferably composed of silicone or has silicone, and the material of the inner bushing section is composed of a silicone-free material.

In order to allow a simple current measurement, it is considered to be advantageous for at least one bushing element to in each case be equipped with a current transformer for each switch pole. Additionally or alternatively, at least one bushing element can be in each case equipped with a capacitive or resistive voltage divider for each switch pole, in order to allow a voltage measurement.

By way of example, the circuit breaker may be a medium-voltage outdoor switch, which is also referred to by a specialist as a recloser, autorecloser or automatic circuit recloser, that is to say a switch which can be used up to voltages of about 52 kV.

The switching elements preferably have vacuum interrupters; alternatively, however, switching elements or interrupters may be used which are filled with SF₆ gas or oil.

The invention also relates to a method for production of a circuit breaker, in which at least one switching element is arranged in a housing, with each switching element in each case having a longitudinal direction which corresponds to the current flow direction when the switching element is switched on.

In order to achieve as small a physical size as possible for a method such as this, the invention proposes that the circuit breaker has three poles and is equipped with three switching elements whose longitudinal directions are aligned parallel, with the three switching elements being arranged alongside one another on a cross-sectional plane which is located at right angles to said longitudinal directions, such that the switching elements form corner points of an imaginary or virtual triangle. The invention will be explained in more detail in the following text with reference to exemplary embodiments; in this case, by way of example:

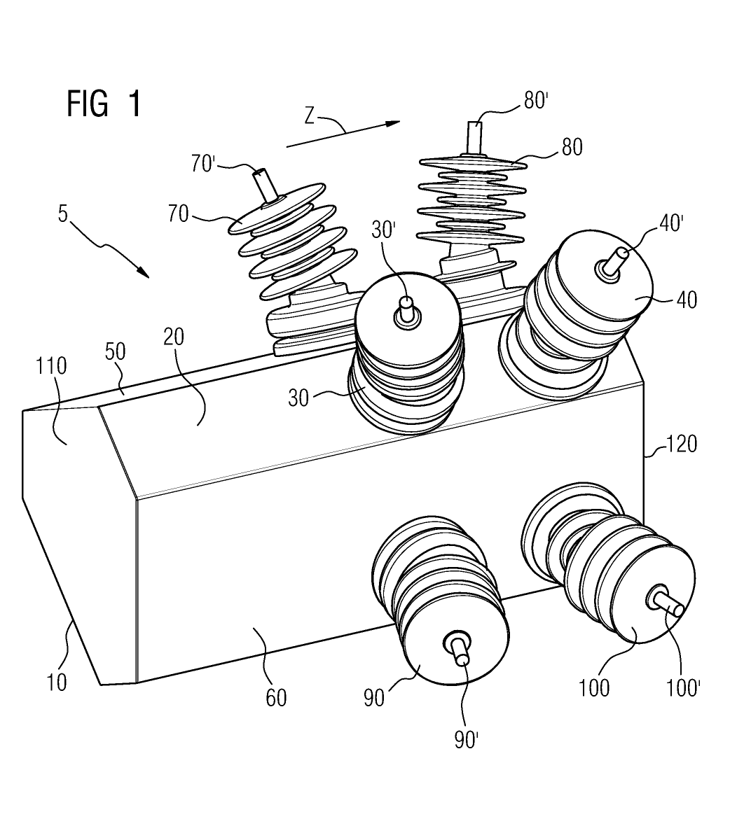

FIG. 1 shows one exemplary embodiment of a circuit breaker according to the invention, in the form of a three-dimensional view from the side,

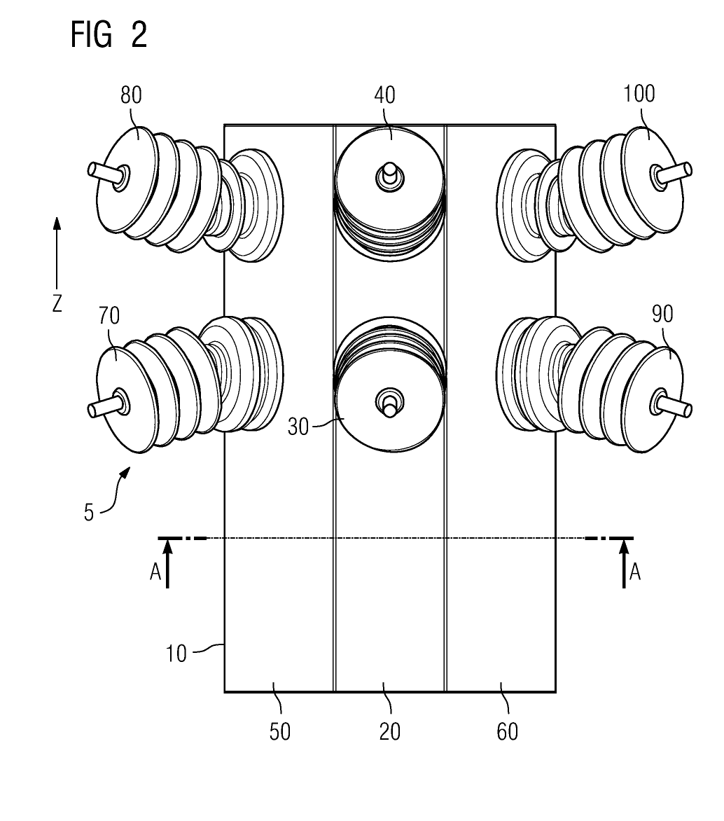

FIG. 2 shows the circuit breaker as shown in FIG. 1, in a view from above,

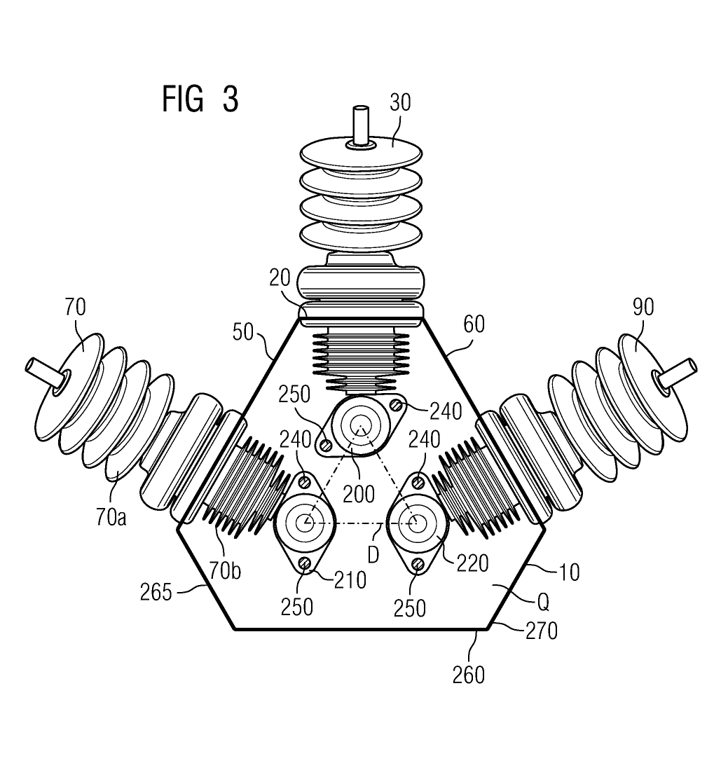

FIG. 3 shows the circuit breaker as shown in FIG. 1, in a cross section along the section plane defined in FIG. 2,

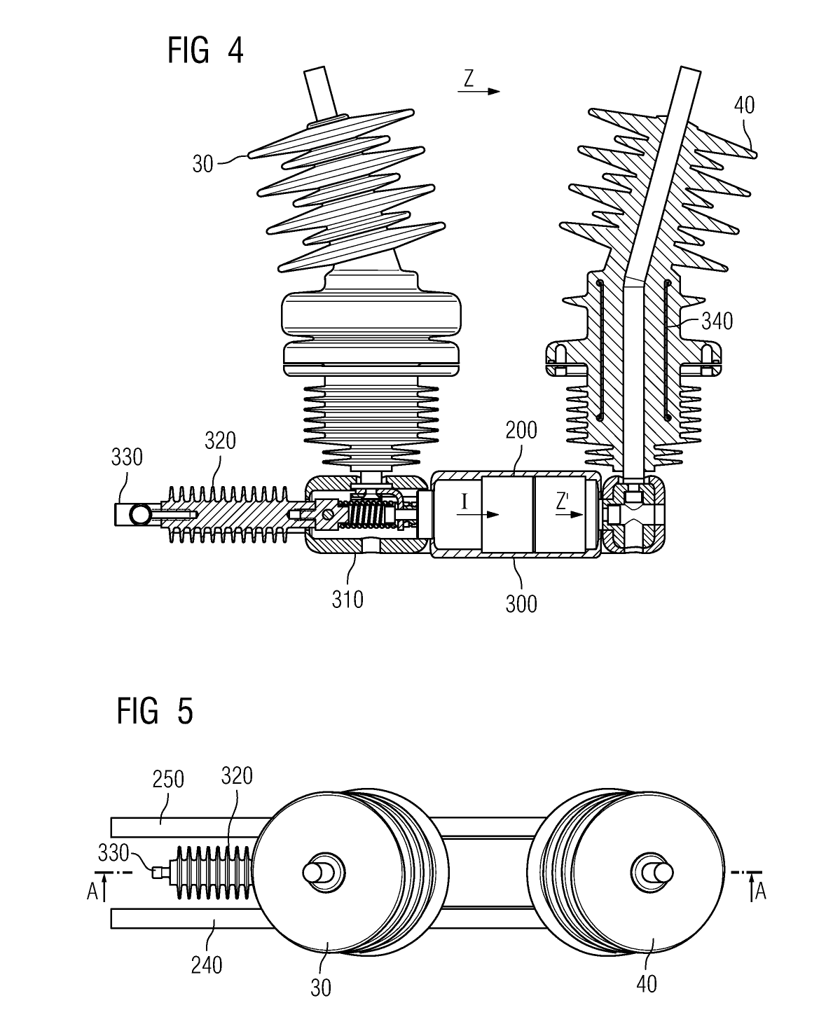

FIG. 4 shows one exemplary embodiment of a switching element with the bushing elements connected to it, for the circuit breaker as shown in FIGS. 1 to 3,

FIG. 5 shows the switching element with the associated bushing elements, in a view from above,

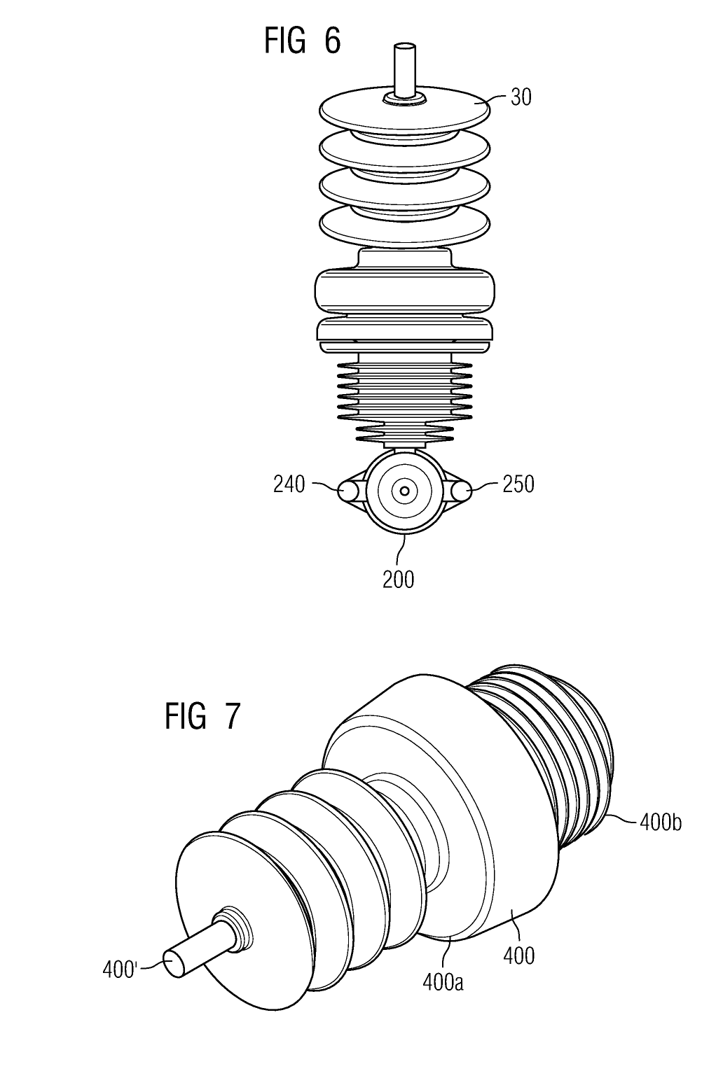

FIG. 6 shows the switching element shown in FIG. 4, in a view from the front,

FIG. 7 shows one exemplary embodiment of a bushing element for the circuit breaker as shown in FIG. 1, in a three-dimensional view,

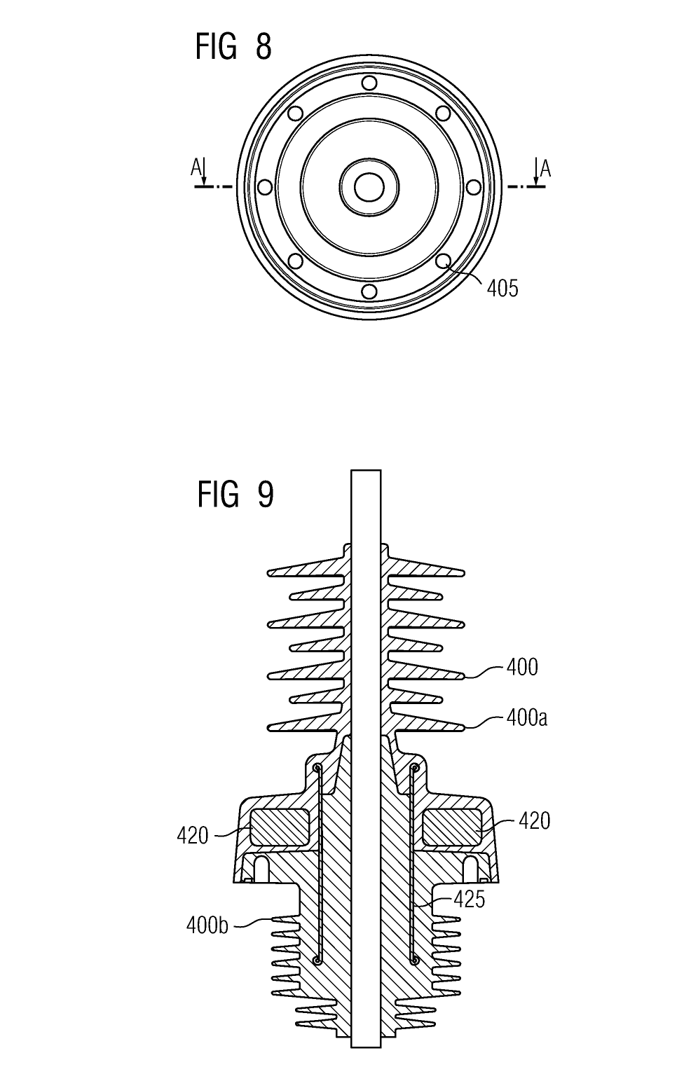

FIG. 8 shows the bushing element shown in FIG. 7, in a view from underneath,

FIG. 9 shows the bushing element shown in FIG. 7 in a side view with a current transformer integrated in it and with a capacitive voltage divider integrated in it,

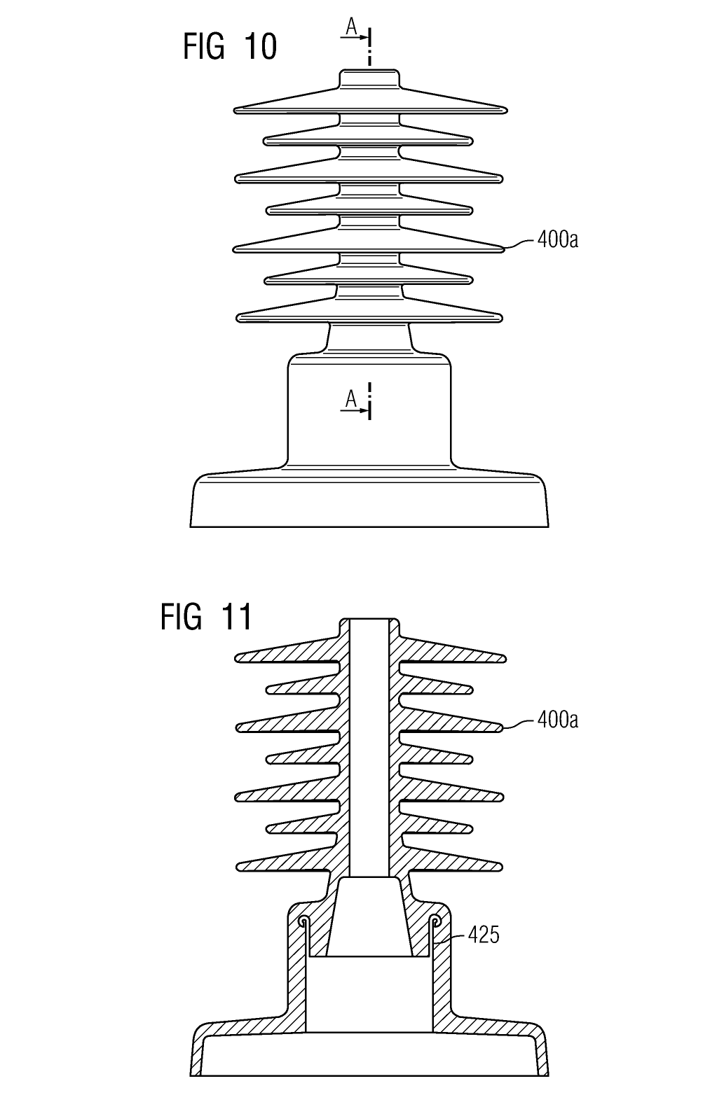

FIG. 10 shows one exemplary embodiment of an outer bushing section of a bushing element with a capacitive voltage divider, but without an integrated current transformer,

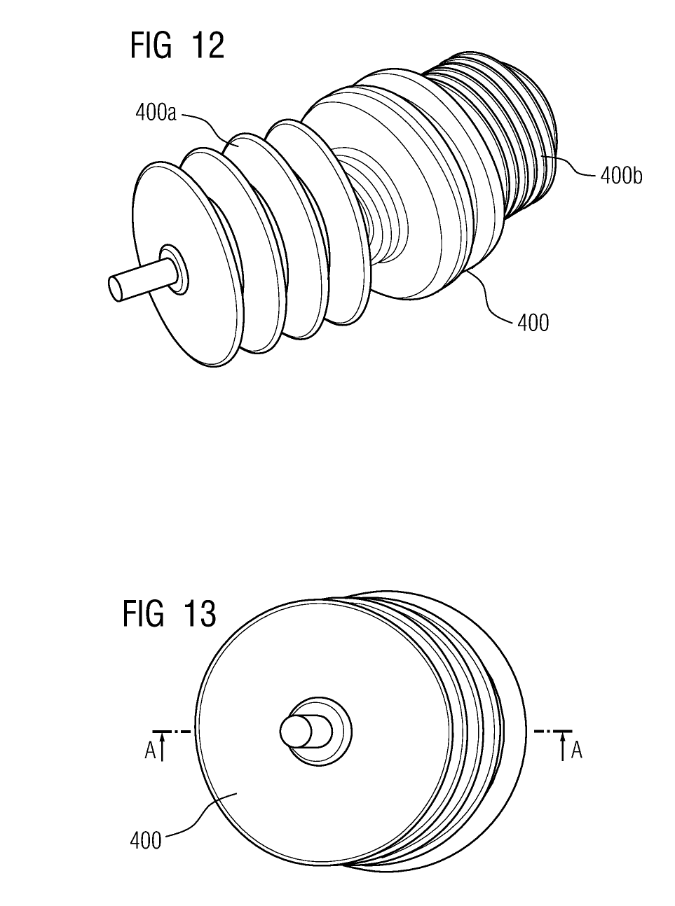

FIG. 11 shows the outer bushing section shown in FIG. 10, in the form of a cross section,

FIG. 12 shows an exemplary embodiment of a bushing element of integral design,

FIG. 13 shows the bushing element as shown in FIG. 12, in a different view, and

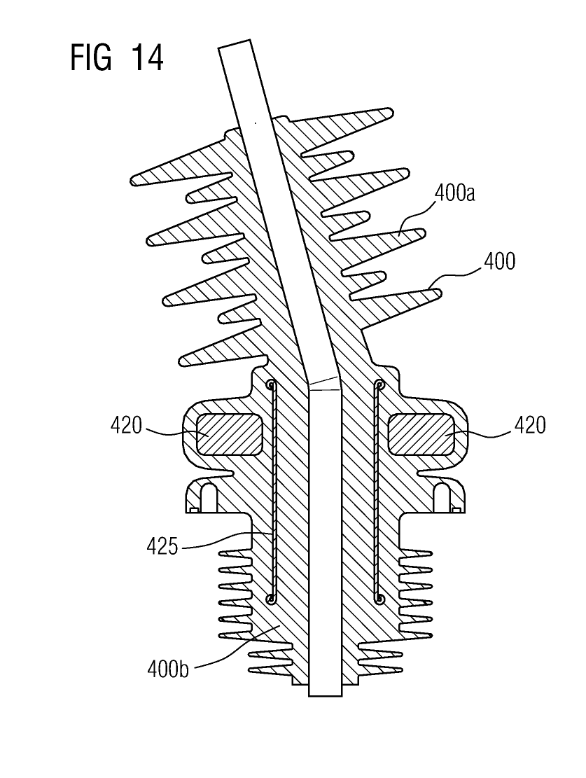

FIG. 14 shows the bushing element shown in FIG. 12, in the form of a cross section.

For the sake of clarity, the same reference symbols are used for identical or comparable components in FIGS. 1 to 14.

FIG. 1 shows one exemplary embodiment of a medium-voltage outdoor switch 5, in a three-dimensional view from the side. The figure shows a housing 10 with an upper cover wall 20, on which two upper bushing elements 30 and 40 are mounted. The upper bushing element 30 is located in front of the upper bushing element 40 along the housing longitudinal direction Z.

In addition, FIG. 1 shows two side walls of the housing 10, to be precise a left-hand side wall 50 and a right-hand side wall 60. Two bushing elements are in each case mounted on each of the two side walls 50 and 60, and are located one behind the other on each of the two side walls, in each case in the housing longitudinal direction Z. In FIG. 1, the bushing elements are annotated with the reference symbols 70 and 80 for the left-hand side wall 50 and with the reference symbols 90 and 100 for the right-hand side wall 60 in FIG. 1.

In addition, FIG. 1 shows a front end wall 110 and a rear end wall 120. The two end walls 110, 120 are used for mechanical attachment to switching elements which are located within the housing 10; this will be explained in more detail further below.

The outer electrical connections of the bushing elements are annotated with the reference symbols 30′, 40′, 70′, 80′, 90′ and 100′ in FIG. 1.

FIG. 2 illustrates the circuit breaker 5 shown in FIG. 1, in a view from above. This shows the six bushing elements 30, 40, 70, 80, 90 and 100 which are mounted on the cover wall 20 and the two side walls 50 and 60, or are passed through them. The housing longitudinal direction Z is also shown.

FIG. 3 illustrates the circuit breaker 5 shown in FIG. 1 in the form of a cross section along the section line A-A shown in FIG. 2. The cross-sectional area Q is therefore at right angles to the housing longitudinal direction Z.

Furthermore, FIG. 3 shows that the bushing elements each have two bushing sections, specifically an outer bushing section, which is located outside the housing, and an inner bushing section, which is located within the housing 10. The outer bushing section of the bushing element 70 is annotated with the reference symbol 70a, and the inner bushing section is annotated with the reference symbol 70b.

In addition, FIG. 3 shows switching elements 200, 210 and 220 which are arranged ‘symmetrically’ and form corner points of an imaginary equilateral triangle, all the sides of which are essentially of the same length and which are each at an angle of at least approximately 60 degrees to one another. The imaginary equilateral triangle D is represented by a dashed line in FIG. 3.

As can be seen, the three switching elements 200, 210, 220 are each held by the associated bushing elements, which are mounted on the cover wall 20 and on the two side walls 50 and 60. In order to achieve a position, which is furthermore stable, of the switching elements within the housing 10, each of the switching elements is each equipped with two stabilization rods, which are annotated with the reference symbols 240 and 250 in FIG. 3. As can be seen, the stabilization rods for each switching element are arranged slightly rotated, so that one of the two stabilization rods, specifically the stabilization rod 240, is located closer to the associated bushing element than the respective other stabilization rod 250. The stabilization rods 240 and 250 are respectively connected to the front and rear end walls 110 and 120, in order to ensure a stable position.

By way of example, the switching elements may be formed by interrupters, for example by vacuum interrupters or by interrupters, which are filled with SF₆ gas.

FIG. 3 also shows a base wall 260, which is arranged parallel to the cover wall 20 and is adjacent to two connection walls 265 and 270, one of which connects the base wall 260 to the left-hand side wall 50, and the other connects the base wall 260 to the right-hand side wall 60.

The cover wall 20 and the two side walls 50 and 60 are preferably each at an angle of between 115 degrees and 125 degrees, preferably of 120 degrees, to one another.

The connection walls 265 and 270 each form an angle of between 115 degrees and 125 degrees, preferably of 120 degrees, with the base wall 260 and the associated side wall 50 or 60.

By way of example, FIG. 4 shows the arrangement comprising the two bushing elements 30 and 40 and the associated switching element 200, in a side view and in the form of a longitudinal section. As can be seen, the switching element 200 has a switching section 300, a mechanical drive section 310, a mechanical operating section 320 and a connection 330 for connection of an external drive. The mechanical operating section 320, may, for example, be formed by a rod which switches the switching section 300 on and off by a reciprocating movement along the housing longitudinal direction, or the Z direction. The housing longitudinal direction Z and the longitudinal direction Z′ of the switching element 200 are parallel to one another, as a result of which the current flow direction I of a current which is flowing through the switching element 200 coincides with the longitudinal direction Z′ of the switching element 200, and runs parallel to the housing longitudinal direction Z.

As can also be seen, the upper bushing element 40 is equipped with a capacitive voltage divider, which is annotated with the reference symbol 340.

The arrangement of the bushing elements and of the associated switching element as illustrated in FIG. 4 corresponds to the other bushing elements and the other switching elements 210 and 220.

FIG. 5 shows the arrangement of the two bushing elements 30 and 40 and of the associated stabilization rods 240 and 250 in a view from above. The figure also shows the mechanical operating section 320 and the connection 330.

FIG. 6 shows an alternative arrangement of the stabilization rods 240 and 250, which differs from the arrangement shown in FIG. 3. In contrast to the example shown in FIG. 3, in the example shown in FIG. 6, the arrangement of the stabilization rods 240 and 250 is symmetrical relative to the associated bushing element, as a result of which the two stabilization rods 240 and 250 are at the same distance from the associated bushing element and the associated attachment surface to which the associated bushing element is attached.

FIG. 7 shows one exemplary embodiment 400 of the bushing elements 30, 40, 70, 80, 90 and 100. The exemplary embodiment shown in FIG. 7 relates to a bushing element in which the outer bushing section 400a is composed of a different material to that of the inner bushing section 400b. The outer electrical connection is annotated with the reference symbol 400′.

FIG. 8 shows the bushing element in a view from underneath. The figure shows holes 405 which allow the bushing element 400 to be attached or screwed on or to a side wall of a housing.

FIG. 9 shows the bushing element 400, in the form of a section. The figure shows the outer bushing section 400a and the inner bushing section 400b, as well as the fact that they are composed of different materials. The figure also shows that a current transformer 420 is integrated in the outer bushing section 400a.

Furthermore, the bushing element 400 is equipped with a capacitive voltage divider 425, which extends both in the inner bushing section 400b and in the outer bushing section 400a. Furthermore, the capacitive voltage divider 425 forms a shield in order to influence the electrical field in the bushing area through the housing wall.

The upper bushing section 400a is preferably composed of a material which is suitable for outdoor use; this should be understood as meaning a material which allows the upper bushing section 400a to be used in an outdoor environment. By way of example, one material which is suitable for outdoor use is plastic that is suitable for outdoor use, for example in the form of a cycloaliphatic casting resin, or silicone. The inner bushing section 400b is preferably composed of a material which is not suitable for outdoor use, for example for cost reasons, for example a casting resin which is not suitable for outdoor use or a thermoplastic such as EPDM (ethylene-propylene-diene rubber).

FIGS. 10 and 11 show an alternative exemplary embodiment of the outer bushing section 400a of the bushing element 400 as shown in FIG. 7. The outer bushing section 400a differs from the outer bushing section shown in FIG. 9 in that an integrated current transformer has been omitted. The upper bushing section 400a is equipped only with a capacitive voltage divider 425.

FIGS. 12, 13 and 14 show a further exemplary embodiment of a bushing element 400, which is suitable for the circuit breaker shown in FIG. 1. FIGS. 12 and 13 show the bushing element 400 in the form of a three-dimensional view.

FIG. 14 shows the bushing element in the form of a cross section. As can be seen, both the inner bushing section 400b and the outer bushing section 400a are composed of one and the same material. This material is preferably suitable for outdoor use, in order that the circuit breaker 5 can be installed externally, for example on pylons of overhead line networks. The bushing element 400 is equipped both with a current transformer 420 and with a capacitive voltage divider 425.

1-22. (canceled)

23. A circuit breaker, comprising:
a housing;
three poles, and three switching elements disposed in said housing, for switching electric current;
each said switching element having a longitudinal direction corresponding to a current flow direction of the electric current when said switching element is switched on, or being parallel thereto;
said three switching elements having said longitudinal directions parallel to one another; and
said three switching elements being disposed alongside one another on a cross-sectional plane defined at right angles to said longitudinal directions, and forming corner points of an imaginary triangle.

24. The circuit breaker according to claim 23, wherein said three switching elements form corner points of an imaginary equilateral triangle.

25. The circuit breaker according to claim 23, wherein said housing has a cover wall, and two upper bushing elements that are connected to one of said three switching elements project through said cover wall.

26. The circuit breaker according to claim 25, wherein said two upper bushing elements are located one behind the other in the longitudinal direction of the respectively associated said switching element.

27. The circuit breaker according to claim 25, which comprises two side walls adjacent said cover wall.

28. The circuit breaker according to claim 27, wherein each of said side walls encloses an angle of between 115 degrees and 125 degrees with said cover wall.

29. The circuit breaker according to claim 27, wherein each of said side walls encloses an angle of substantially 120 degrees with said cover wall.

30. The circuit breaker according to claim 27, which comprises two side bushing elements in each case projecting through each of said two side walls and electrically associated with a switching element, wherein said bushing elements are disposed one behind the other on each side wall in the longitudinal direction of the respectively associated said switching element.

31. The circuit breaker according to claim 30, wherein said upper bushing elements and said side bushing elements each forms an external connection of the circuit breaker.

32. The circuit breaker according to claim 25, wherein said housing has a base wall configured for supporting said circuit breaker, said base wall extending parallel to said cover wall.

33. The circuit breaker according to claim 32, wherein said housing includes two connection walls, one of said connection walls connects said base wall to one of said two side walls, and another one of said connection walls connects said base wall to the other of said two side walls.

34. The circuit breaker according to claim 33, wherein at least one of said connection walls encloses an angle of between 115 degrees and 125 degrees with said base wall and/or an associated said side wall.

35. The circuit breaker according to claim 34, wherein said angle is substantially 120 degrees.

36. The circuit breaker according to claim 23, wherein the longitudinal directions of said switching elements run parallel to a longitudinal direction of said housing.

37. The circuit breaker according to claim 25, wherein each of said bushing elements has an outer bushing section, disposed outside said housing, and an inner bushing section, disposed within said housing, and wherein said outer and inner bushing sections are composed of mutually different materials or said outer and inner bushing sections have mutually different materials.

38. The circuit breaker according to claim 37, wherein a material of said outer bushing section is configured for outdoor use, and a material of said inner bushing section is configured for outdoor use.

39. The circuit breaker according to claim 37, wherein the material of said outer bushing section is composed of silicone or includes silicone, and the material of the inner bushing section is composed of a silicone-free material.

40. The circuit breaker according to claim 23, which comprises at least one bushing element in each case equipped with a current transformer for each switch pole.

41. The circuit breaker according to claim 23, which comprises at least one bushing element in each case equipped with a capacitive or resistive voltage divider for each switch pole.

42. The circuit breaker according to claim 23, configured as a medium-voltage outdoor switch.

43. The circuit breaker according to claim 23, wherein said switching elements are vacuum interrupters.

44. The circuit breaker according to claim 23, wherein said switching elements are interrupters filled with SF₆ gas.

45. A method of producing a circuit breaker, the method which comprises:
arranging at least one switching element in a housing, with each switching element in each case having a longitudinal direction corresponding to a current flow direction when the switching element is switched on, or extending parallel thereto;
providing the circuit breaker with three poles and with three switching elements having mutually parallel longitudinal directions;
arranging the three switching elements alongside one another on a cross-sectional plane that is located at right angles to that longitudinal directions, such that the switching elements form corner points of an imaginary triangle.

46. A bushing element for a circuit breaker, comprising an outer bushing section for mounting outside a housing of the circuit breaker, and an inner bushing section for mounting within the housing, wherein said outer bushing section and said inner bushing section are composed of mutually different materials or have mutually different materials.

47. In combination with the circuit breaker according to claim 23, a bushing element for the circuit breaker, comprising:
an outer bushing section for mounting outside the housing of the circuit breaker; and
an inner bushing section for mounting within the housing of the circuit breaker;
wherein said outer bushing section and said inner bushing section are composed of mutually different materials or have mutually different materials.
